(19) United States
(12) Patent Application Publication
(10) Pub. No.: US 2004/0060947 A1
(43) Pub. Date: Apr. 1, 2004

(54) Metering pump and valve assembly for use in the same

(76) Inventor: Constantijn Thomas Papaikonomou, The Hague (NL)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/256,117

(22) Filed: Sep. 26, 2002

(51) Int. Cl. B67D 5/40

(52) U.S. Cl. 222/144; 222/380; 222/490; 222/494

(57) ABSTRACT

A metering pump for viscous fluids, such as cosmetics ingredients and paint colorants, is disclosed which includes a self-sealing valve member at the outlet of the pump to prevent undispensed fluid from solidifying or clogging the outlet and further which enhances the accuracy of the pump.

### BACKGROUND

1. Technical Field

A metering pump for dispensing a fluid, such as cosmetic ingredients and paint colorants, a valve assembly for one or more of such pumps, and an apparatus comprising a plurality of such pumps are disclosed.

2. Background of the Related Art

A prior art pump of this type is disclosed U.S. Pat. No. 6,003,731. FIGS. 16 and 19a-19d of this publication show a pumping arrangement adapted to suck fluid from a package and to press it out in order to dispense the fluid in a desired dosage.

However, there is a need for a pump and a valve assembly for dispensing cosmetic ingredients, paint colorants and the like, which makes such fluids less likely to solidify and clog the valve or outlet, and/or which allows the accurate dispensing of small amounts of fluids, including low viscosity fluids such as aqueous solutions.

### SUMMARY OF THE DISCLOSURE

A metering pump for dispensing a fluid is disclosed that comprises at least one outlet opening for dispensing the fluid, said opening being covered by a self-sealing valve member.

A disclosed valve assembly for a pump for dispensing a fluid comprises a housing having at least one outlet opening for dispensing the fluid, at least one inlet opening and a self-sealing valve member which covers the outlet opening.

It is preferred that the valve member comprise a marginal, preferably annular, sealing portion about the outlet opening and a head portion including a central area with an orifice which opens to permit fluid flow therethrough in response to a predetermined discharge pressure within said pump or housing, and which closes to shut off fluid flow therethrough upon removal of the predetermined discharge pressure.

Thus, the fluid remaining in the pump near the outlet opening is more effectively prevented from solidifying and clogging the valve or outlet and/or the pump is also capable of dispensing small amounts of low viscosity fluids.

It is further preferred that the head portion of the valve member extend substantially within the upper and lower rim of the marginal portion.

An apparatus for dispensing viscous fluids, comprising a plurality of pumps as described above. It is preferred that, the apparatus further comprises a means, such as a brush or a resilient strip, for wiping the self-sealing valve member of at least one of the pumps.

This apparatus can be used, e.g., as a dispenser for several different pigments, colorants, base paints and/or additives, such as solvents or binders, which can be mixed with each other or, e.g., with a further base paint, at a point of sale.

The disclosed apparatuses will be further explained with reference to the drawings in which a preferred embodiment according to the disclosure is schematically illustrated.

### BRIEF DESCRIPTION OF THE DRAWINGS

FIG. 1 is a perspective view of a disclosed apparatus for dispensing viscous fluids;

FIG. 2 is a perspective view of a pump for dispensing viscous fluids;

FIGS. 3 to 6 illustrate respectively two perspective views, a front view, and a cross-sectional view of a modular valve assembly in accordance with the disclosure;

FIG. 7 illustrates a detail B of FIG. 6;

FIGS. 8A to 9B illustrate a valve assembly according to the disclosure associated with a cleaning device;

FIG. 10 is a perspective view of a valve assembly of a second embodiment of an apparatus for dispensing viscous fluids;

FIGS. 11 and 12 illustrate respectively a bottom view and a cross-sectional view of the dispensing head according to FIG. 10.

It is noted that the drawings are not necessarily to scale and that details, which are not necessary for understanding the present invention, may have been omitted. The terms “upper,” “lower,” “horizontal,” “vertical” and the like relate to the embodiments as oriented in the figures, not any particular use of the disclosed embodiments.

### DETAILED DESCRIPTION OF THE PRESENTLY PREFERRED EMBODIMENTS

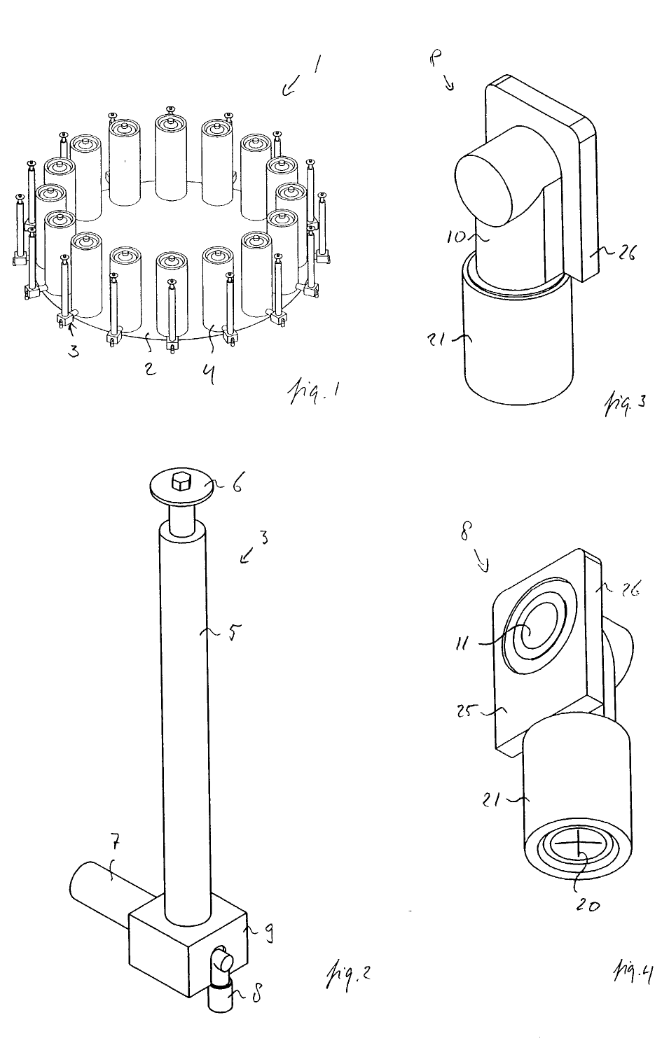

FIG. 1 illustrates an example of an apparatus 1 for dispensing fluids, such as paints, paint colorants or dyes. This particular dispensing apparatus 1 is an automated version and includes a horizontal turntable 2, which can be rotated between discrete positions about a vertical, central axis by means of a drive (not shown).

On the turntable 2, a plurality of pumps 3 are mounted, in this case sixteen pumps. Each pump 3 is connected to a fluid container 4, e.g., a stationary type canister, a bag-in-box container or the like. When one of the containers 4 is empty or nearly empty, it should be refilled by pouring fluid, such as a paint colorant, into it or by replacing the empty bag with a filled bag. Further details of a suitable apparatus are disclosed in U.S. Pat. No. 6,273,298, the contents of which are incorporated herein by reference.

FIG. 2 shows one of the piston pumps 3 in more detail. This pump 3 comprises a cylinder 5, which contains, in a manner known in itself, a piston and a piston rod, and a flange 6. The pump 3 further comprises a suction line 7 adapted to be connected to a container 4 and a pressure line terminating in a modular valve assembly 8 according to the disclosure. The flange 6 can be engaged by an actuator (not shown and known in itself) adapted to move the piston rod and hence the piston upwards during an intake stroke and downwards during a discharge stroke. The cylinder 5 is mounted in the top part of a pump housing 9, containing a known valve member, e.g., a ball valve or a cylindrical valve which can be operated by means of a lever (not shown). In an intake position, the cylinder 5 communicates with the container 4 and can be filled with a desired amount of the fluid from the container 4 by moving the flange 6 upwards over a desired or predetermined length. As soon as an appropriate amount has been taken in, the valve member can be rotated to a dispensing position. In this position, the cylinder 5 communicates with the valve assembly 8 and the fluid can be dispensed by moving the flange 6 downwards over a desired or predetermined length.

Other suitable pumps are disclosed in U.S. Pat. No. 6,398,513, concerning nutating pumps, and WO 02/06674, relating to gear pumps.

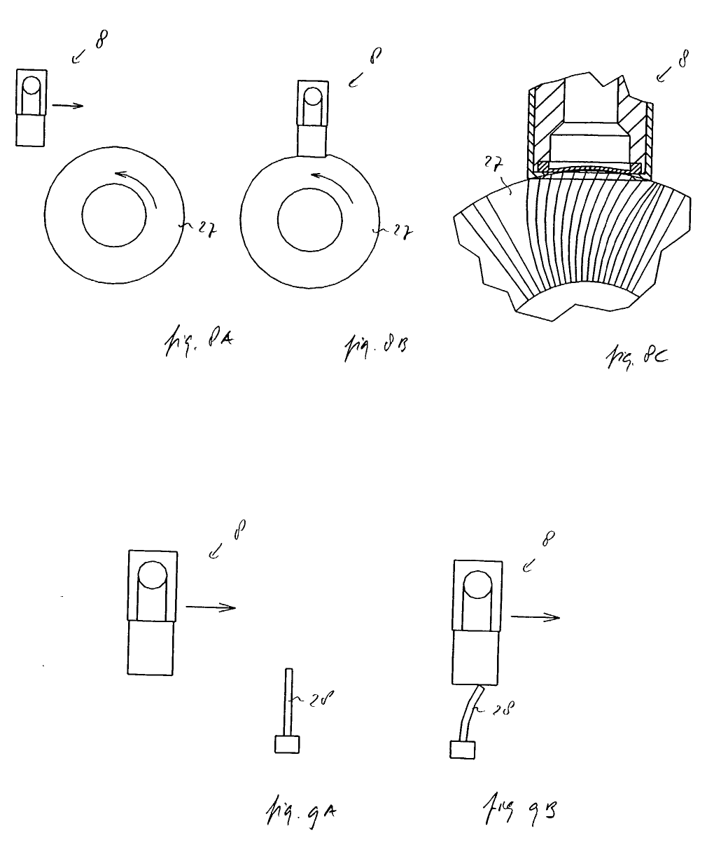

FIGS. 3 to 7 show a valve assembly 8 comprising a housing 10 having an inlet opening 11 and an outlet opening 12 (FIGS. 6 and 7) connected by and internal channel 13. The inlet opening 11 is surrounded by a annular groove 14 containing an annular gasket 15, e.g., a rubber ring. The channel 13 widens downstream near the outlet opening 12. The outlet opening 12 is surrounded by an annular recess 16, which accommodates a self-sealing valve member 17.

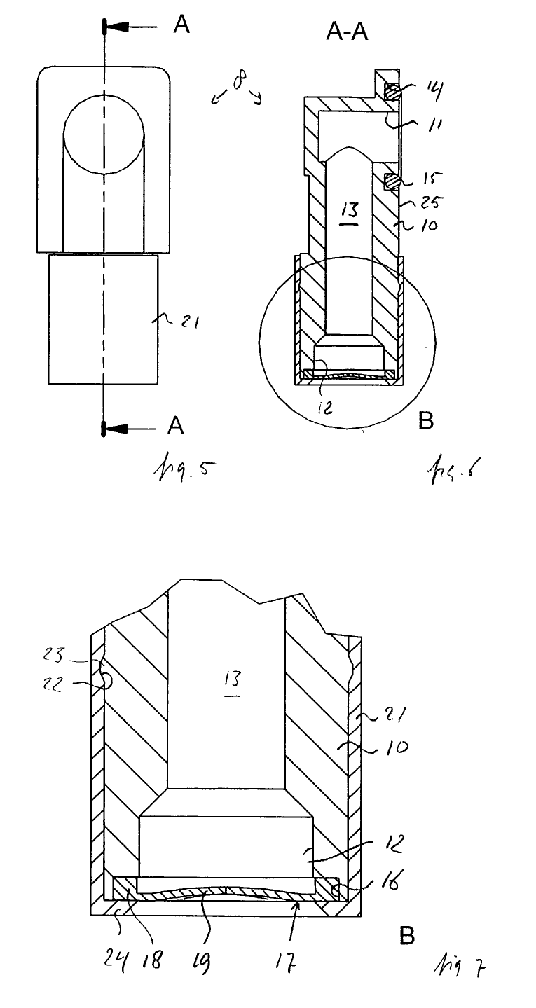

The valve member 17 comprises a marginal, annular portion 18 sealing about the outlet opening 12 of the housing 10 and a head portion 19 including a central area with an orifice 20, preferably comprising two crossing slits (as shown in FIG. 4), which opens to permit fluid flow therethrough in response to a predetermined discharge pressure within the pump 3 and hence the channel 13 and closes to shut off fluid flow therethrough upon removal of the predetermined discharge pressure. When the valve member 17 is closed, the exterior surface of the head portion 19 assumes a generally concave orientation (as viewed from the outside of the pump) so as to cause the valve member 17 to open abruptly once the mentioned discharge pressure is reached. It is preferred that the valve member 17 is moulded from a resilient material, such as a rubber, preferably silicone rubber. It was surprisingly found that disposable valve members are suitable for (relatively) prolonged used in an apparatus, pump and valve assembly as discussed above. Examples of suitable disposable valve members are disclosed in U.S. Pat. Nos. 5,033,655 and 5,439,143, which are incorporated herein by reference. However, it is preferred that the head portion 19 of the valve member 17 extends at least substantially within the upper and lower rim of the marginal portion, i.e., that the valve member 17 is at least substantially flat. Thus, a tendency of the valve member to deform between a state of rest (no fluid flow) and during fluid flow is reduced. When dispensing a fluid, such deformation alters the volume of the channel 13 and interferes with dispensing accuracy, especially when small amounts of low viscosity fluids are being dispensed.

The valve member 17 is held in place by means of a sleeve 21, which is mounted about the housing 10 of the valve assembly 8. The inner wall of the sleeve 21 is provided with an annular groove 22 snap-fitted over one or more protrusions 23 on the outer surface of the housing 10. The sleeve 21 further comprises an inwardly projecting lower rim 24 abutting the lower surface of the marginal portion 18 of the valve member 17 and pushing the same firmly against the lower surface of the housing 10. To facilitate cleaning of the valve member 17, it is preferred that the exterior surface of the head portion 19 and the rim 24 of the sleeve 21 are at least substantially flush. Preferably, the distance between the exterior surface of the head portion and the lower surface of the sleeve is less than 1 mm, e.g., 0.5 mm, so as to further reduce fouling and/or facilitate the cleaning of the valve member 17.

The inlet opening 11 of the housing 10 extends through a wall 25 of the housing 10, which wall 25 is flat and delimited on two opposite sides by parallel edges 26 which can be slidably received in corresponding grooves (not shown) in or on the pump 3. This slidable connection facilitates replacement of the valve assembly 8 during maintenance of the pump 3. As mentioned, the resilient gasket 15 extends beyond the surface of the wall 25. As a result, an effective clamping force between the modular valve assembly 8 and the pump 3 ensured.

FIGS. 8A to 8C schematically show a rotary brush 27, which can be associated with one or more pumps 3 of the apparatus 1. During cleaning, the distance from the central portion of the valve member 17 to the rotational axis of the brush should be less than the distance from the tips of the bristle in the brush to the said rotational axis. It is preferred that the rotational axis is stationary with respect to the rotational axis of the turntable 2 and that the valve assemblies 8 in the apparatus 1 are brought into contact with the brush by rotating the turntable 2 to an appropriate position. An alternative to the brush 27, i.e., a rubber strip 28, which, upon relative movement of the strip and the valve assembly 6, wipes the valve member(s) 17, is shown in FIGS. 9A and 9B.

From the above disclosed preferred embodiment, it will be clear that the invention allows the more accurate dispensing of small amounts of fluids (including low viscosity fluids), reduces exposure of the fluid in the pump and valve assembly to the environment thus suppressing solidification, and/or allows effective cleaning of the dispense opening and efficient and simple replacement of a worn or clogged valve assembly with a new valve assembly.

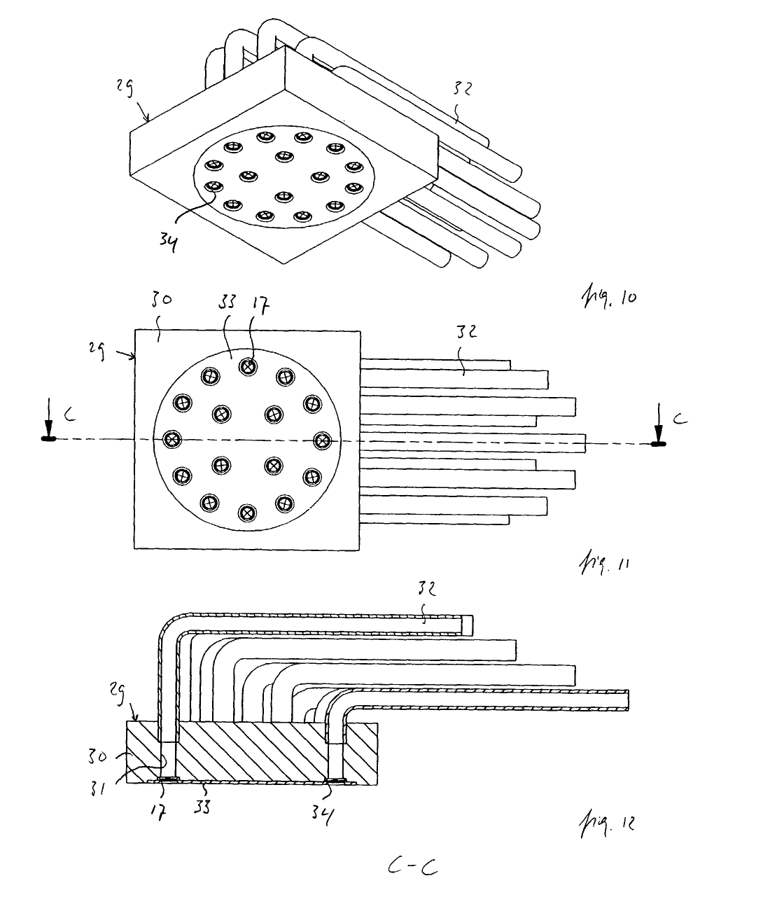

FIGS. 10 to 12 show a valve assembly 29 for a second example of an apparatus 1 for dispensing fluids, which comprises a housing 30 provided with, in this particular example, sixteen straight channels 31. A hose or tube 32 has been firmly secured in one (inlet) end of each of the channels 31, whereas a self-sealing valve member 17 as described above has been placed in an annular recess 16 at the other (outlet) end of each of the channels 31. All valve members 17 are held in place by means of a plate 33, comprising sixteen holes 34 and attached to the housing 30 by means of screws (not shown). The positions of these holes 34 correspond to the positions of the outlets of the channels 31 and have diameters larger than the diameters of the head portions 19 of the valve members 17 and smaller than those of the marginal portions 18. The remaining end of each of the tubes 32 are attached to a corresponding number of pumps, e.g., gear pumps or a nutating pumps as discussed above, which are each fluidly connected to a container. To facilitate cleaning of the valve member 17, the plate 33 has a thickness in a range from 0.5 to 1.0 mm.

This particular embodiment is especially suitable for dispensing relatively large quantities of, e.g., paint colorants at a point of sale.

As a matter of course, this disclosure is not restricted to the above disclosed embodiment, which may be varied in different manners within the spirit and scope of the invention. For example, the valve assembly can be configured as an integral (non-modular) part of the pump. As a further example, the above-mentioned parts, in particular the housing of the valve assembly, can be made of any suitable material, e.g., a metal, such as stainless steel, of a polymer material, such as POM or PEEK.

What is claimed is:

1. A metering pump comprising at least one outlet opening for dispensing the fluid, wherein said opening is covered by a self-sealing valve member.

2. The metering pump of claim 1, wherein the valve member comprises a marginal portion comprising an upper rim and a lower rim, the marginal portion sealing about the outlet opening, the valve member further comprising a head portion comprising an exterior surface and a central area with an orifice which opens to permit fluid flow therethrough in response to a predetermined discharge pressure within said pump and closes to shut off fluid flow therethrough upon removal of the predetermined discharge pressure.

3. The metering pump of claim 2, wherein the head portion extends at least substantially within the upper and lower rim of the marginal portion.

4. The metering pump of claim 2, wherein the exterior surface of at least the central area of the head portion assumes a generally concave orientation as viewed from the outside of the pump.

5. The metering pump of claim 2, wherein a sleeve is mounted about the discharge opening, and the sleeve comprises an inwardly projecting rim and wherein the marginal portion of the valve member is clamped down by the inwardly projecting rim.

6. The metering pump of claim 5, wherein the exterior surface of the head portion and the rim of the sleeve are substantially flush.

7. The metering pump of claim 2, wherein the valve member is molded from a resilient material.

8. A valve assembly for a pump comprising:
a housing having at least one outlet opening for dispensing the fluid and at least one inlet opening and
a self-sealing valve member which covers the outlet opening.

9. The valve assembly of claim 8, wherein the valve member comprises a marginal portion sealing about the outlet opening of the housing, the marginal portion comprising an upper and lower rim, the valve member further comprising a head portion comprising an exterior surface and a central area with an orifice which opens to permit fluid flow therethrough in response to a predetermined discharge pressure within said housing, and closes to shut off fluid flow therethrough upon removal of the predetermined discharge pressure.

10. The valve assembly of claim 9, wherein the head portion extends substantially within the upper and lower rim of the marginal portion.

11. The valve assembly of claim 9, wherein the exterior surface of at least the central area of the head portion assumes a generally concave orientation as viewed from the outside of the housing.

12. The valve assembly of claim 9, wherein a sleeve is mounted about the housing and the discharge opening, the sleeve comprises an inwardly projecting rim and wherein the marginal portion of the valve member is clamped between the housing and the inwardly projecting rim.

13. The valve assembly of claim 8, wherein the inlet opening of the housing extends through a wall of the housing and wherein this wall is shaped to be slidably connectable with and an outlet opening of a pump.

14. The valve assembly of claim 13, wherein the wall comprises an exterior surface and a resilient gasket is positioned about the inlet of the housing and extends beyond the exterior surface of the wall.

15. The valve assembly of claim 13, wherein two opposite edges of the wall are adapted to be received in corresponding grooves in or on the pump.

16. An apparatus for dispensing viscous fluids, comprising a plurality of pumps according to claim 1.

17. The apparatus of claim 16, wherein the apparatus further comprises a means for wiping the self-sealing valve member of at least one of the pumps.

18. A metering pump comprising:
at least one outlet opening for dispensing the fluid, wherein said opening is covered by a self-sealing valve member;
wherein the valve member comprises a marginal portion comprising an upper rim and a lower rim the marginal portion sealing about the outlet opening, the valve member further comprising a head portion comprising an exterior surface and a central area with an orifice which opens to permit fluid flow therethrough in response to a predetermined discharge pressure within said pump and closes to shut off fluid flow therethrough upon removal of the predetermined discharge pressure; and
wherein the head portion extends at least substantially within the upper and lower rim of the marginal portion.

19. A valve assembly for a pump comprising:
a housing having at least one outlet opening for dispensing the fluid and at least one inlet opening;
a self-sealing valve member which covers the outlet opening;
wherein the valve member comprises a marginal portion sealing about the outlet opening of the housing, the marginal portion comprising an upper and lower rim, the valve member further comprising a head portion comprising an exterior surface and a central area with an orifice which opens to permit fluid flow therethrough in response to a predetermined discharge pressure within said housing, and closes to shut off fluid flow therethrough upon removal of the predetermined discharge pressure; and
wherein the head portion extends substantially within the upper and lower rim of the marginal portion.
